(19) United States
(12) Patent Application Publication
(10) Pub. No.: US 2014/0082379 A1
(43) Pub. Date: Mar. 20, 2014

(54) POWERING A DISPLAY CONTROLLER

(71) Applicant: APPLE INC., Cupertino, CA (US)

(72) Inventors: Prasanna Nambi, Cupertino, CA (US); Paolo Sacchetto, Cupertino, CA (US); Eric G. Smith, Palo Alto, CA (US); William C. Athas, San Jose, CA (US)

(73) Assignee: APPLE INC., Cupertino, CA (US)

(21) Appl. No.: 13/622,259

(22) Filed: Sep. 18, 2012

(51) Int. Cl. G06F 1/26

(52) U.S. Cl. CPC G06F 1/263
USPC 713/300

(57) ABSTRACT

A method and system are described for powering a display controller in an electronic device. In the described embodiments, the display controller includes a display controller power management circuit directly connected to a battery.

### BACKGROUND

1. Field

The described embodiments relate to techniques for powering a display controller. More specifically, the described embodiments relate to techniques for powering a display controller in an electronic device that includes a battery.

2. Related Art

Typically, a display controller in a battery-powered electronic device, such as laptop computer or tablet computer, is configured to operate from a standardized, fixed input voltage, such as 3.3 volts. The use of a standardized input voltage allows display controller manufacturers to design circuits and power systems in the display controllers that can be used by a wide variety of electronic devices. In order to generate the standardized input voltage, battery-powered electronic devices are often designed with a voltage converter, such as a buck converter, that converts the voltage from a system power management circuit to the standardized voltage for input to the display controller. This standardized voltage often has lower fluctuations than the voltage from the battery and may be more immune to voltage variations due to changes in demand from other systems in the electronic device. However, the voltage conversion process has some efficiency losses, and for a battery-powered device, these efficiency losses may result in a reduction of battery life per charge for the electronic device.

### BRIEF DESCRIPTION OF THE FIGURES

FIG. 1 presents a block diagram illustrating an electronic device in accordance with described embodiments.

FIG. 2 presents a display power management circuit in accordance with described embodiments.

In the figures, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

The methods and processes described in this detailed description can be included in hardware modules. For example, the hardware modules can include, but are not limited to one or more, application-specific integrated circuit (ASIC) chips, field-programmable gate arrays (FPGAs), other programmable-logic devices, and microcontrollers. When the hardware modules are activated, the hardware modules perform the methods and processes included within the hardware modules. In some embodiments, the hardware modules include one or more general-purpose circuits that are configured by executing instructions (program code, firmware, etc.) to perform the methods and processes.

In the following description, we refer to “some embodiments.” Note that “some embodiments” describes a subset of all of the possible embodiments, but does not always specify the same subset of embodiments.

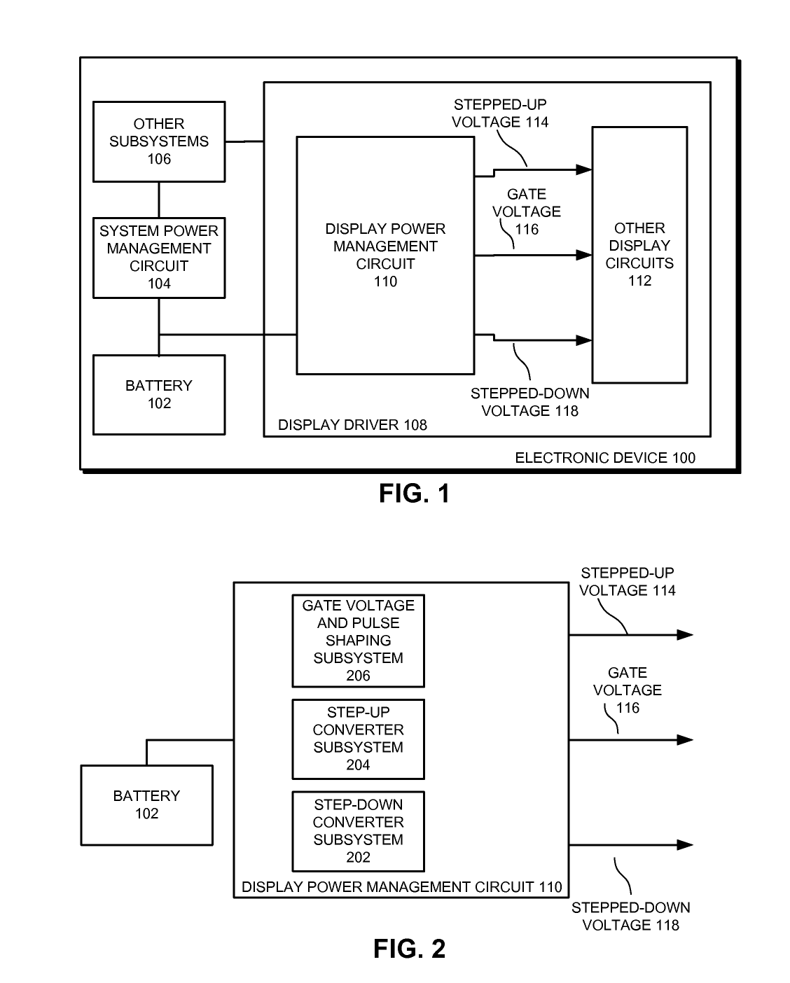

FIG. 1 presents a block diagram illustrating an electronic device in accordance with described embodiments. Electronic device 100 includes battery 102 coupled directly to system power management circuit 104 and display power management circuit 110 in display driver 108. System power management circuit 104 is coupled to other subsystems 106 which is coupled to display driver 108. Display driver 108 includes display power management circuit 110 and other display circuits 112. Display power management circuit 110 outputs stepped-up voltage 114, gate voltage 116, and stepped-down voltage 118 to other display circuits 112.

Electronic device 100 can be (or can be included in) any device that includes a battery and a display driver. For example, electronic device 100 can be (or can be included in) a laptop computer, a subnotebook/netbook, a tablet computer, a cellular phone, a personal digital assistant (PDA), a smartphone, or another device.

Battery 102 may be any battery or battery system including one or more batteries and/or battery cells coupled together in any parallel or series configuration to output any desired voltage and/or current. For example, battery 102 may have one (1S), two (2S), three (3S), or more cells in series and any number in parallel. Battery 102 may be implemented in any battery chemistry, including but not limited to a rechargeable battery chemistry such as nickel metal hydride (NiMH), lithium polymer, lithium ion, or any other battery chemistry.

System power management circuit 104 may be any power management circuit implemented in any technology and may include any combination of hardware and software, and digital and analog circuitry. System power management circuit 104 may include one or more systems on a chip (“SOCs”), microcontrollers, and/or other hardware modules, and may be implemented on one or more integrated circuits. System power management circuit 104 provides power at the voltage levels required by subsystems of electronic device 100 in other subsystems 106. In embodiments in which battery 102 is a rechargeable battery system, system power management circuit 104 may include a battery management unit that receives power from an adapter (not shown) to charge battery 102. In some embodiments, the battery management unit may be implemented in circuits not included in system power management circuit 104. Note that in embodiments in which battery 102 is a rechargeable battery and system power management circuit 104 receives power from an adapter (not shown), the power received from the adapter may be used to recharge battery 102 and/or power display power management circuit 110.

Other subsystems 106 represents all of the other subsystems (other than those included in display driver 108) that may be present in electronic device 100 and may include but is not limited to one or more processing subsystems (e.g., CPUs), memory subsystems (e.g., volatile and non-volatile), displays (e.g., driven by display driver 108), communications subsystems, data collection subsystems, audio and/or video subsystems, alarm subsystems, media processing subsystems, and/or input/output (I/O) subsystems.

Display driver 108 includes display power management circuit 110 and other display circuits 112. Display power management circuit 110 drives a display such as a thin film transistor (TFT) liquid crystal display (LCD), which may be included in other subsystems 106. Display power management circuit 110 is a power management circuit implemented in any technology and may include any combination of hardware and software, and digital and analog circuitry. Display power management circuit 110 may include one or more SOCs, microcontrollers, and/or other hardware modules, and may be implemented on one or more integrated circuits. The operation of display power management circuit 110 will be discussed in more detail below with reference to FIG. 2.

Other display circuits 112 includes display circuits that are powered by voltage generated by display power management circuit 110, including stepped-up voltage 114, gate voltage 116 and stepped-down voltage 118. Other display circuits 112 may include one or more of the following circuits implemented on one or more integrated circuits: programmable gamma volt generator, timing controller, column driver, and gate driver.

FIG. 2 presents a block diagram illustrating display power management circuit 110 in accordance with described embodiments. Display power management circuit 110 is directly connected to battery 102 and includes step-down converter subsystem 202, step-up converter subsystem 204, and gate voltage and pulse shaping subsystem 206. Note that in some embodiments other voltage generating subsystems may be included in display power management circuit 110. In the embodiment of FIG. 2, the output from battery 102 is connected to and powering display power management circuit 110 without first passing through another power management circuit or other voltage converter in electronic device 100 (e.g., system power management circuit 104, a step-up converter and/or a step-down converter). In some embodiments, the voltage from battery 102 is input into display power management circuit 110 across one or more filtering capacitors (not shown).

Step-down converter subsystem 202 can be any step-down converter implemented in any technology and includes a compensation loop control system. In some embodiments, the compensation loop includes a response time of 600 microseconds or faster. Note that the response time and gain of the compensation loop may be determined based on one or more factors, including but not limited to the discharge profile of battery 102, and the expected fluctuations in the voltage from battery 102 as a user uses electronic device 100. For example, during use of electronic device 100, one or more subsystems in other subsystems 106 may increase their power requirements (e.g., a processor may enter a “turbo” mode or a universal serial bus device may be plugged in). The compensation loop of step-down converter subsystem 202 may then be selected so that the output voltage of step-down converter subsystem 202 remains within the voltage tolerance for other display circuits 112. In some embodiments, step-down converter subsystem 202 is a current mode controlled buck converter with compensation loop that has a bandwidth of 10 kHz or more. Additionally, in some embodiments, step-down converter subsystem 202 includes a buck converter that converts the voltage from battery 102 to 1.2 volts for output as stepped-down voltage 118 to other display circuits 112.

Step-up converter subsystem 204 can be any step-up converter implemented in any technology and includes a compensation loop control system. In some embodiments, the compensation loop includes a response time of 600 microseconds or faster. The response time and gain of the compensation loop for step-up converter subsystem 204 may be determined based on factors similar to those used to determine these parameters for step-down converter subsystem 202, and can be selected so that the output voltage of step-up converter subsystem 204 remains within the voltage tolerance for other display circuits 112. In some embodiments, step-up converter subsystem 204 is a current mode controlled boost converter with compensation loop that has a bandwidth of 10 kHz or more. Note that in some embodiments the efficiency of step-up converter subsystem 204 may be higher when step-up converter subsystem 204 receives power directly from battery 102 at a higher voltage (e.g., 3.8 volts) than the voltage that might be received by step-up converter subsystem 204 if the output of battery 102 were first regulated (e.g., by a buck converter) to a lower voltage (e.g., 3.3 volts) before being received by step-up converter subsystem 204.

Gate voltage and pulse shaping subsystem 206 is any subsystem that generates and shapes one or more gate voltages for use by other display circuits 112. In some embodiments, gate voltage and pulse shaping subsystem 206 may include a charge pump. Furthermore, in some embodiments, gate voltage and pulse shaping subsystem 206 may receive input from step-up converter subsystem 204 and/or step-down converter subsystem 202.

Note that in some embodiments, the loop compensation and filtering parameters for one or more of step-down converter subsystem 202, step-up converter subsystem 204, and gate voltage and pulse shaping subsystem 206 may be chosen based on factors including but not limited to reducing grey scale errors in a display driven by display driver 108 when the voltage powering display power management circuit 110 transitions from a lower voltage to a higher voltage (e.g., from being power by battery 102 at a low state of charge, to being power by an adapter through system power management circuit 104) or vice-versa.

In some embodiments, battery 102 is a 1S battery with an output voltage that varies between 3 and 4.5 volts. In these embodiments, display power management circuit 110 is implemented in a technology (e.g., silicon) that is capable of operating over the voltage range output by battery 102. In some of these embodiments, display power management circuit 110 is implemented in silicon so that it operates over a range of voltages from battery 102 that can be from 3.2 volts or less to 3.8 volts or more, which in some embodiments, may include 4 volts or higher. Furthermore, in some of these embodiments, display power management circuit 110 includes a reference voltage generation circuit that generates a reference voltage for use by display power management circuit 110 and/or circuits in other display circuits 112.

Although shown as separate subsystems in FIG. 2, in some embodiments, some or all of a given subsystem can be integrated into one or more of the other subsystems in display power management circuit 110. Although alternative embodiments can be configured in this way, for clarity we describe the subsystems separately.

Although we use specific subsystems to describe display power management circuit 110, in alternative embodiments, different subsystems may be present in display power management circuit 110. For example, display power management circuit 110 may include one or more additional step-down converter subsystems 202, step-up converter subsystems 204, and/or gate voltage and pulse shaping subsystems 206. Additionally, one or more of the subsystems may not be present in display power management circuit 110. Moreover, in some embodiments, display power management circuit 110 may include one or more additional subsystems that are not shown in FIG. 2.

### Alternative Embodiments

Although the subsystems of a display power management circuit are described as an example, in some embodiments, some or all of the above-described functions are implemented using different mechanisms. For example, in some embodiments, one or more separate integrated circuit chips perform the indicated operations. In these embodiments, the integrated circuit chips can include specialized circuits that implement some or all of the above-described operations.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A system for powering a display controller in an electronic device, comprising:
a battery; and
the display controller, wherein the display controller includes a display controller power management circuit connected directly to the battery.

2. The system of claim 1, wherein:
the display controller power management circuit is configured to operate from an input voltage over the range from 3.2 volts or less to 3.8 volts or more.

3. The system of claim 1, wherein:
the display controller management circuit is configured to operate from an input voltage greater than 4 volts.

4. The system of claim 1, wherein:
the display controller management circuit includes a reference voltage generation circuit.

5. The system of claim 1, wherein:
the display controller further includes a buck converter coupled to the battery and configured to generate an output voltage of 1.2 volts.

6. The system of claim 1, wherein:
the display controller management circuit includes a current mode control compensation feedback loop configured to operate over a voltage range output by the battery.

7. The system of claim 6, wherein:
a response time for the current mode control compensation loop is 600 microseconds or less.

8. The system of claim 7, wherein:
the battery is a 1S battery.

9. A method for powering a display controller from a battery in an electronic device, comprising:
receiving an input voltage from the battery to power the display controller; and
generating one or more voltage sources on the display controller from the input voltage received from the battery, wherein a voltage level for each voltage source results from no more than one voltage up-conversion process or one voltage down-conversion process.

10. The method of claim 9, wherein:
generating the one or more voltage sources on the display controller includes generating a 1.2 volt voltage source from the input voltage received from the battery using one voltage down-conversion process.

11. The method of claim 9, wherein:
generating one or more voltage sources on the display controller from the input voltage received from the battery includes filtering a fluctuation of the input voltage from the battery.

12. The method of claim 9, wherein:
the input voltage received from the battery to power the display controller varies over a voltage range from 3.2 volts or less to 3.8 volts or more.

13. A system for powering a display controller in an electronic device, comprising:
a battery; and
a display controller power management circuit included in the display controller, wherein the display controller power management circuit includes a single stage DC/DC converter connected directly to the battery.

14. The system of claim 13, wherein:
the direct connection between the battery and the single stage DC/DC converter is an unregulated direct connection.

15. The system of claim 13, wherein:
the single stage DC/DC converter is configured to operate from an input voltage over the range from 3.2 volts or less to 3.8 volts or more.

16. The system of claim 13, wherein:
the single stage DC/DC converter is a reference voltage generation circuit.

17. The system of claim 13, wherein:
the single stage DC/DC converter is a step-down converter; and
the display controller power management circuit further includes a second single stage DC/DC converter connected directly to the battery, wherein the second single stage DC/DC converter is a step-up converter.

18. The system of claim 13, wherein:
the single stage DC/DC converter includes a current mode control compensation feedback loop configured to operate over a voltage range output by the battery.

19. The system of claim 18, wherein:
a response time for the current mode control compensation loop is 600 microseconds or less.

20. The system of claim 13, wherein:
the battery is a 1S battery.
